(19) United States
(12) Patent Application Publication
(10) Pub. No.: US 2015/0319318 A1
(43) Pub. Date: Nov. 5, 2015

(54) IMAGE-READING APPARATUS AND IMAGE PROCESSING METHOD

(71) Applicant: PFU LIMITED, Ishikawa (JP)

(72) Inventors: Kensuke HASHIMOTO, Ishikawa (JP); Osamu MIYAKAWA, Ishikawa (JP); Masayuki MIZUSAKO, Kyoto (JP)

(21) Appl. No.: 14/459,304

(22) Filed: Aug. 13, 2014

(30) Foreign Application Priority Data
Apr. 30, 2014 (JP) 2014-094256

(51) Int. Cl. H04N 1/00; H04N 1/21

(52) U.S. Cl. CPC H04N 1/00103; H04N 1/2166; H04N 1/00795; H04N 2201/0081; H04N 2201/0087; H04N 2201/0055; H04N 2201/0096

(57) ABSTRACT

In the present invention, an image-reading apparatus tries to connect to an access point based on stored access point information. When connection to the access point is successful, the image-reading apparatus performs wireless connection in a communication via access point mode through a wireless local area network communication chip that is capable of performing the wireless connection in the communication via access point mode and a direct communication mode.

### CROSS-REFERENCE TO RELATED APPLICATION

This application is based upon and claims the benefit of priority from Japanese Patent Application No. 2014-094256, filed on Apr. 30, 2014, the entire contents of which are incorporated herein by reference.

### BACKGROUND OF THE INVENTION

1. Field of the Invention

The present invention relates to an image-reading apparatus and an image processing method.

2. Description of the Related Art

Techniques have been disclosed in which communication is performed by switching an infrastructure mode and an ad hoc mode.

An information processing apparatus is disclosed in which, when connection is not established in the infrastructure mode, a reason of the connection failure is exchanged by communication in the ad hoc mode (refer to JP-A-2008-182439).

An image transfer system is disclosed in which, when wireless connection cannot be maintained in the infrastructure mode, wireless connection can be maintained by switching to the ad hoc mode (refer to JP-A-2010-239449).

A radiation image photographing apparatus is disclosed in which wireless communication is tried to be established with a console in the infrastructure mode when communication in the infrastructure mode is set as a communication mode, and if the communication cannot be established, the wireless communication is performed in the ad hoc mode (refer to JP-A-2012-165919).

An in-vehicle data communication apparatus is disclosed in which an infrastructure communication mode and an ad hoc communication mode can be automatically switched (refer to JP-A-2013-141126).

In the conventional information processing apparatus (e.g., JP-A-2008-182439), however, has a problem in that it is not supposed that an image-reading apparatus is carried to and used at various places like a home, a workplace, and a business trip destination.

### SUMMARY OF THE INVENTION

It is an object of the present invention to at least partially solve the problems in the conventional technology.

An image-reading apparatus according to one aspect of the present invention includes a wireless local area network communication chip that is capable of performing wireless connection in a communication via access point mode and a direct communication mode, an access point information storage unit that stores access point information about a plurality of access points, an access point connection controlling unit that tries to connect to an access point based on the access point information stored in the access point information storage unit, and a wireless connection controlling unit that performs the wireless connection in the communication via access point mode when the connection to the access point is successful.

An image processing method according to another aspect of the present invention is executed by an image-reading apparatus, the image processing method including an access point connection controlling step of trying to connect to an access point based on access point information stored in an access point information storage unit that stores the access point information about a plurality of access points, and a wireless connection controlling step of performing wireless connection in a communication via access point mode through a wireless local area network communication chip that is capable of performing the wireless connection in the communication via access point mode and a direct communication mode, when the connection to the access point is successful.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a use example of an image-reading apparatus according to an embodiment;

FIG. 2 is a hardware structure diagram of an example of a structure of the image-reading apparatus according to the embodiment;

FIG. 3 is a functional block diagram of an example of the structure of the image-reading apparatus according to the embodiment;

FIG. 4 is a flowchart of an example of processing according to the image-reading apparatus of the embodiment;

FIG. 5 is a flowchart of an example of the processing according to the image-reading apparatus of the embodiment;

FIG. 6 is a conceptual schematic diagram of an example of access point search processing according to the embodiment;

FIG. 7 is a conceptual schematic diagram of an example of the access point search processing according to the embodiment;

FIG. 8 is a flowchart of an example of the processing according to the image-reading apparatus of the embodiment; and

FIG. 9 is a flowchart of an example of the processing according to the image-reading apparatus of the embodiment.

### DETAILED DESCRIPTION OF THE EXEMPLARY EMBODIMENTS

The following explains embodiments of an image-reading apparatus and an image processing method according to the invention in detail with reference to the accompanying drawings. The embodiments do not limit the invention. In the embodiments, the image-reading apparatus is explained as a manual feed type (a continuous document mechanism (CDF) type) document scanner in some cases. The image-reading apparatus is not limited to this example, and may be an automatic document feed (ADF) type document scanner, a flatbed type document scanner, an overhead type image-reading apparatus, or other apparatuses. In Particular, the image processing method according to the embodiments can be applied to images acquired by any type of the image-reading apparatus such as the CDF type document scanner, the ADF type document scanner, the flatbed type document scanner, or the overhead type image-reading apparatus.

### 1. Overview of an Embodiment of the Invention

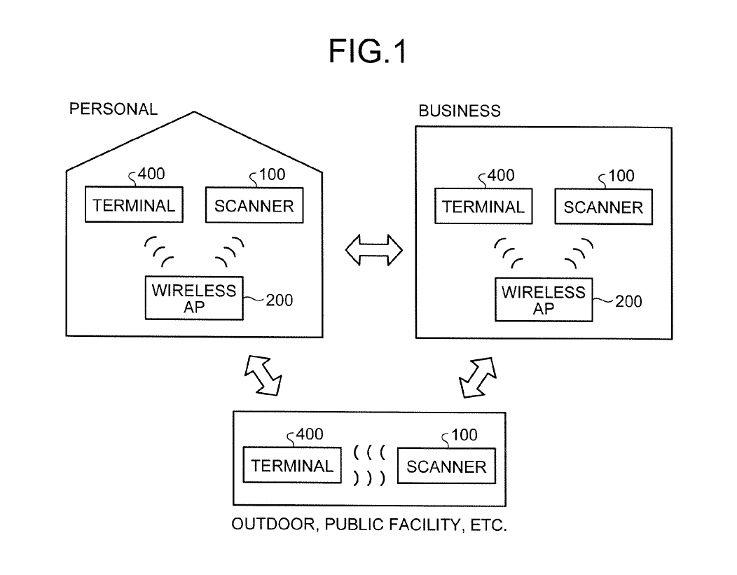

The following explains an overview of an embodiment of the invention with reference to FIG. 1, and thereafter a structure and processing and the like of the embodiment according to the invention are explained in detail. FIG. 1 is a schematic diagram of a use example of an image-reading apparatus 100 according to the embodiment.

As shown in FIG. 1, in the embodiment, a user preliminarily registers access points (wireless APs) 200 that the user can use in an environment where the user uses the image-reading apparatus (scanner) 100, like a personal environment or a business environment. As a result, in the embodiment, the registered access point and the image-reading apparatus (scanner) 100 can wirelessly communicate with each other without requiring for the user to change the setting of the wireless connection every time even when the image-reading apparatus (scanner) 100 is operated by being carried to and used in the user's home, office, or other environments.

In the embodiment, the image-reading apparatus (scanner) 100 and a terminal device (terminal) 400 can wirelessly communicate with each other in a direct communication mode without requiring for the user to change the setting of the wireless connection even when the image-reading apparatus (scanner) 100 is used in environments like at business trip destinations, outdoors, or public facilities, that is, environments where the access points (wireless APs) 200, which the user can use, are not present. As a result, the embodiment makes it possible to reduce a period of time to reach a state where the wireless communication can be performed and to perform optimum power saving control in both modes in such environments.

### 2. Structure of the Embodiment

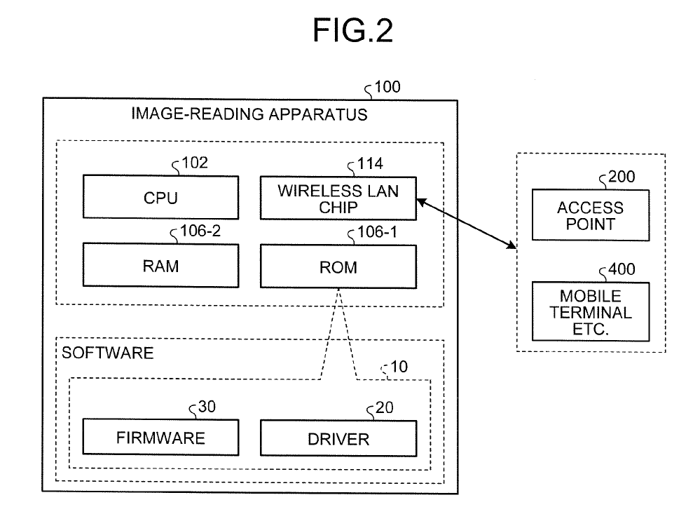

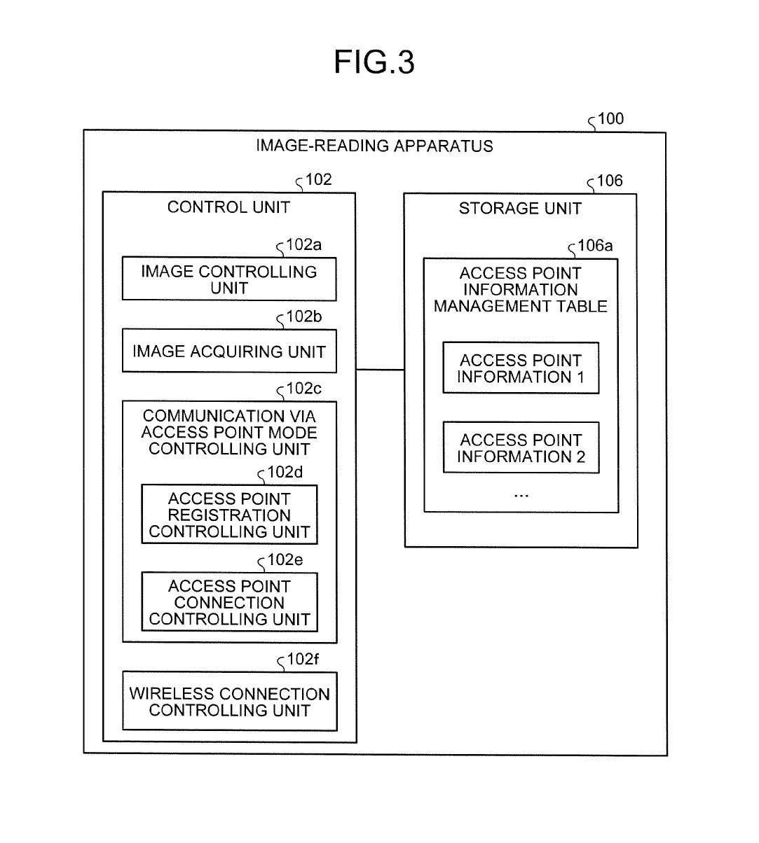

The following explains an example of the structure of the image-reading apparatus 100 according to the embodiment of the invention with reference to FIGS. 2 and 3. Thereafter, the processing and the like of the embodiment are explained in detail. FIG. 2 is a hardware structure diagram of an example of the structure of the image-reading apparatus 100 according to the embodiment. FIG. 3 is a functional block diagram of an example of the structure of the image-reading apparatus 100 according to the embodiment.

As shown in FIG. 2, software 10 (firmware 30 and a driver 20) that provides functions of the invention is written into a read only memory (ROM) 106-1 in the image-reading apparatus 100 after being compiled. The firmware 30 may be a main program that controls the functions of the invention. The driver 20 may be a program that controls hardware (a wireless local area network (LAN) communication chip (wireless LAN chip) 114) used in the image-reading apparatus (scanner) 100.

In the embodiment, once the firmware 30 operates, the whole system of the image-reading apparatus (scanner) 100 operates. The firmware 30 controls the wireless LAN communication chip (wireless LAN chip) 114 using the driver 20. The wireless LAN communication chip (wireless LAN chip) 114 may communicate with an external device using a wireless LAN to transmit and receive data. In the embodiment, the firmware 30 and the driver 20 stored in the ROM 106-1 may be loaded on a random access memory (RAM) 106-2 and executed in cooperation with a central processing unit (CPU) 102.

The wireless LAN communication chip (wireless LAN chip) 114 may automatically select a “communication via access point mode” in which the image-reading apparatus 100 is connected to the external access point 200 and a “direct communication mode” in which the image-reading apparatus 100 can communicate directly with a terminal device (mobile terminal) 400. The ROM 106-1 can store setting information about a plurality of access points, that is, an access point information management table 106a.

As shown in FIG. 3, the image-reading apparatus 100 schematically includes a storage unit 106 including a memory and a control unit 102 (an image controlling unit 102a, an image acquiring unit 102b, a communication via access point mode controlling unit 102c, and a wireless connection controlling unit 102f). The image-reading apparatus 100 may be a mobile type image-reading apparatus (i.e., a mobile type scanner or other apparatuses). The image-reading apparatus 100 may include the wireless LAN communication chip 114, which is omitted in FIG. 3. The wireless LAN communication chip 114 may be a single chip (single core), that is, may have a single chip structure. In the embodiment, when connection in the communication via access point mode is tried and the connection cannot be established, the communication via access point mode is switched to the direct communication mode, thereby making it possible to achieve the same convenience as that of two chips while the wireless LAN chip 114 is a single chip.

The image-reading apparatus 100 may further include an image-reading unit 110 and an input/output unit (I/O unit) 112, which are omitted in FIG. 3. The image-reading apparatus 100 may further include a whole-surface conveying roller. The respective components are coupled to enable communication with each other through any communication path. The control unit 102 may control the image-reading unit 110, the input/output unit (I/O unit) 112, and the wireless LAN communication chip 114.

The storage unit 106 stores any one or both of various databases, various tables and various files. The storage unit 106 is a storage unit. For example, the ROM 106-1, the RAM 106-2, a fixed disk drive like a hard disk drive, and any one or both of a flexible disk drive and an optical disc drive can be used as the storage unit 106. Computer programs that issue commands to the CPU to perform various types of Processing and the like are recorded in the storage unit 106. The storage unit 106 may store data like read images.

The access point information management table 106a, which is one of the components of the storage unit 106, stores access point information about the access point. The access point information may be related to a plurality of access points. For example, as shown in FIG. 3, the access point information management table 106a may store a plurality of pieces of access point information like access point information 1 about an access point 1 and access point information 2 about an access point 2. The access point information management table 106a may further store connection priority order information about a wireless connection priority order associated with the access point. In this way, in the embodiment, the access point information management table 106a may be prepared such that the access point information management table 106a retains a plurality of connectable access points as a list.

The image-reading unit 110 scans a medium (document) and reads the image of the medium (document). The image-reading unit 110 may scan media at one time and read the images of the media. The image-reading unit 110 may start reading the image at the same time when document conveyance to a conveying path is started. In the embodiment, the image-reading unit 110 may include an image sensor like a contact image sensor (CIS). The image-reading unit 110 may include light sources like tri-color (RGB) light emitting diodes (LEDs). The image sensor may convert signals from one-dimensionally arranged light receiving elements into a serial output signal. As a result, a one-dimensional image is output line by line. The control unit 102 produces a two-dimensional image by combining the output one-dimensional images.

The input/output unit 112 inputs and outputs (I/O) data. The input/output unit 112 may be a key input unit, a touch panel, a control pad (e.g., a touch pad or a game pad), a mouse, a keyboard, or a microphone, for example. The input/output unit 112 may be a display unit (e.g., a display, a monitor, or a touch panel including liquid crystal elements or organic electroluminescence (EL) elements) that displays a display screen of an application and the like. The input/output unit 112 may be a voice output unit (e.g., a speaker) that outputs voice information as a voice.

The wireless LAN communication chip 114 performs wireless connection in the communication via access point mode and in the direct communication mode. The wireless LAN communication chip 114 may have a power save mode (a function to reduce power consumption by periodically repeating sleep and wake up while maintaining wireless communication).

The control unit 102 includes a CPU or the like that overall controls the image-reading apparatus 100. The control unit 102 has an internal memory that stores a control program, programs specifying various processing procedures or the like, and necessary data, and performs information processing to execute various types of processing on the basis of the programs.

The control unit 102 includes roughly the image controlling unit 102a, the image acquiring unit 102b, the communication via access point mode controlling unit 102c, and the wireless connection controlling unit 102f.

The image controlling unit 102a controls an image reading. The image controlling unit 102a may control the image reading by the image-reading unit 110. In other words, the image controlling unit 102a may cause the image-reading unit 110 to read a medium. The image controlling unit 102a may cause the image-reading unit 110 to read media at one time.

The image acquiring unit 102b acquires an image. The image acquiring unit 102b may acquire the image (read image) read by the image-reading unit 110. The image acquiring unit 102b may acquire a two-dimensional image by combining one-dimensional images output from the image sensor line by line, for example. The image acquiring unit 102b may acquire an image (read image) when no presence of the medium at a conveyance entrance of the image-reading unit 110 is detected. The image acquiring unit 102b may store the image and the like read by the image-reading unit 110 in the storage unit 106. The image acquiring unit 102b may perform projective transformation on the image read by the image-reading unit 110 (e.g., the read image is projectively transformed as if the image is photographed from the front direction).

The communication via access point mode controlling unit 102c controls wireless connection in the communication via access point mode. The communication via access point mode controlling unit 102c may check whether the access point information management table 106a has an entry of the access point information. The communication via access point mode controlling unit 102c includes, in a functional concept, an access point registration controlling unit 102d and an access point connection controlling unit 102e.

The access point registration controlling unit 102d registers (stores) the access point information about the access point 200 that a user can use in the access point information management table 106a. The access point information may be input by the user through the input/output unit 112.

The access point connection controlling unit 102e tries to connect to the access point based on the access point information stored in the access point information management table 106a. When performing search processing on the access point based on the access point information stored in the access point information management table 106a and receiving no search response from the access point, the access point connection controlling unit 102e may skip a waiting time and perform the search processing on another access point that is different from the access point and based on the access point information stored in the access point information management table 106a.

When receiving a beacon signal and the beacon signal is transmitted from the access point based on the access point information stored in the access point information management table 106a, the access point connection controlling unit 102e may try to connect to the access point that transmits the beacon signal. When receiving a beacon signal and the beacon signal is transmitted from the access point based on the access point information stored in the access point information management table 106a, the access point connection controlling unit 102e may cancel the search for the access point having a low wireless connection priority order (priority) and try to connect to the access point that transmits the beacon signal.

When querying the access point and receiving a response from the access point in receiving the beacon signal including no identification information about the access point, and when the beacon signal is transmitted from the access point based on the access point information stored in the access point information management table 106a after the search processing of all of the access points is completed, the access point connection controlling unit 102e may try to connect to the access point that transmits the beacon signal.

The access point connection controlling unit 102e may try to connect to the access point based on the access point information stored in the access point information management table 106a in accordance with the wireless connection priority order associated with the access point. When the image controlling unit 102a is set to a power saving mode, the access point connection controlling unit 102e may try to connect to the access point based on the access point information stored in the access point information management table 106a in synchronization with the power saving mode.

When the connection to the access point is successful, the wireless connection controlling unit 102f performs wireless connection in the communication via access point mode. When the image controlling unit 102a is set to the power saving mode during the wireless connection controlling unit 102f performing the wireless connection in the communication via access point mode, the wireless connection controlling unit 102f may perform the wireless connection in the communication via access point mode in the power saving mode in synchronization with the power saving mode of the image controlling unit 102a. When the image controlling unit 102a is set to the power saving mode during the wireless connection controlling unit 102f performing the wireless connection in the direct communication mode, the wireless connection controlling unit 102f may perform the wireless connection in the direct communication mode without any synchronization with the power saving mode of the image controlling unit 102a.

When the access point based on the access point information stored in the access point information management table 106a is not found, the wireless connection controlling unit 102f may perform the wireless connection in the direct communication mode. When the access point based on the access point information stored in the access point information management table 106a is found and authentication of the access point is unsuccessful, the wireless connection controlling unit 102f may operate still in the communication via access point mode.

### 3. Processing in the Embodiment

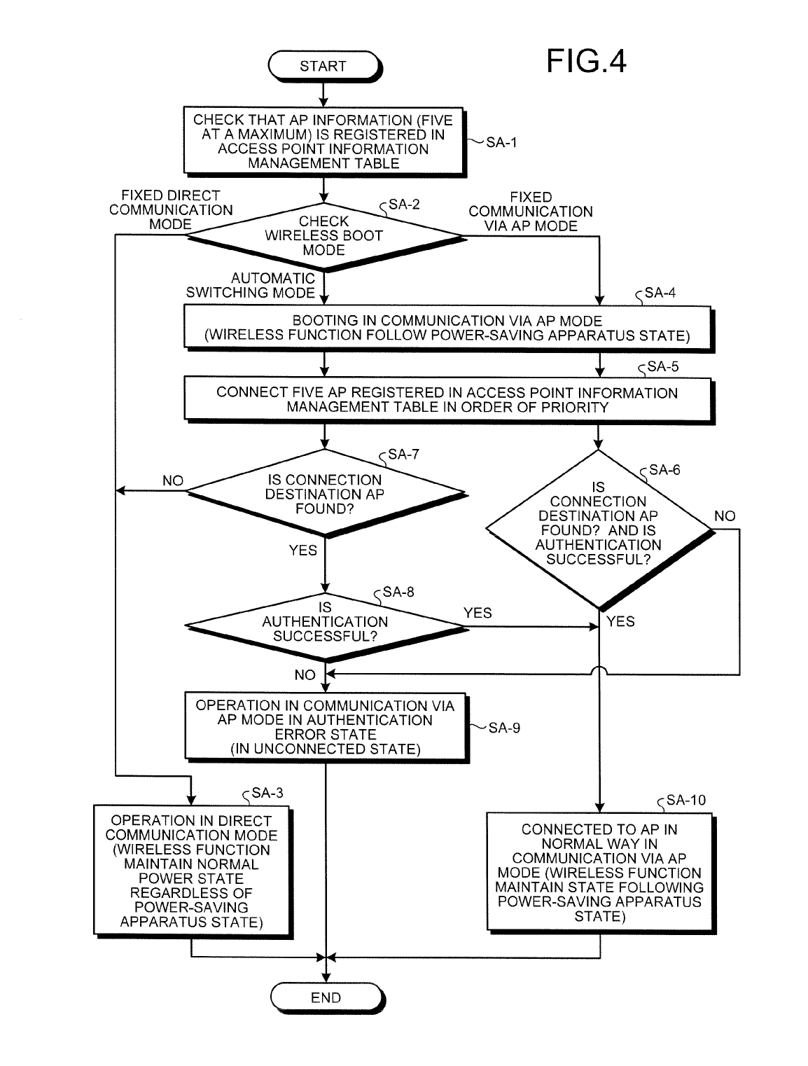

The following explains an example of the processing executed by the image-reading apparatus 100 having the above-described structure with reference to FIGS. 4 to 9. FIG. 4 is a flowchart of an example of the processing according to the image-reading apparatus 100 of the embodiment.

As shown in FIG. 4, the communication via access point mode controlling unit 102c checks that the entry of the access point (AP) information is registered in the access point information management table 106a (step SA-1).

If it is checked that the entry (five entries at a maximum) of the access point (AP) information is registered in the access point information management table 106a, the communication via access point mode controlling unit 102c checks that a wireless boot mode is which one of a fixed direct communication mode, an automatic switching mode, and a fixed communication via access point (AP) mode (step SA-2).

If it is checked that the wireless boot mode is set to the fixed direct communication mode (fixed direct communication mode at step SA-2), the communication via access point mode controlling unit 102c shifts the processing to step SA-3.

The wireless connection controlling unit 102f performs the wireless connection in the direct communication mode (step SA-3), and then ends the Processing. When the image controlling unit 102a is set to the power saving mode (apparatus power-saving state) during the wireless connection controlling unit 102f performing the wireless connection in the direct communication mode, the wireless connection controlling unit 102f may perform the wireless connection in the direct communication mode without any synchronization with the power saving mode of the image controlling unit 102a.

In other words, the wireless function may operate to maintain a normal communication (normal power) state without being set to the power save mode (regardless of the apparatus power-saving state) because it is necessary to instantly response connection requests from various wireless slave devices when the mode is the direct communication mode. In the embodiment, the firmware 30 may instruct the driver 20 to switch the operation to the direct communication mode.

If the communication via access point mode controlling unit 102c checks that the wireless boot mode is set to the fixed communication via access point mode (fixed communication via access point mode at step SA-2), the access point connection controlling unit 102e performs booting in the communication via access point mode (step SA-4) and tries to connect to five access points based on the access point information stored in the access point information management table 106a in accordance with the wireless connection priority orders (in the order of priority) associated with the access points stored in the access point information management table 106a (step SA-5), and then shifts the processing to step SA-6.

When the image controlling unit 102a is set to the power saving mode (apparatus power-saving state), the access point connection controlling unit 102e may operate in the communication via access point mode in synchronization with (following) the power saving mode of the image controlling unit 102a.

The access point connection controlling unit 102e tries to connect to the five access points based on the access point information stored in the access point information management table 106a in accordance with the wireless connection priority orders (in the order of priority) associated with the access points stored in the access point information management table 106a (step SA-5), and then shifts the processing to step SA-6.

The access point connection controlling unit 102e determines whether the connection destination access point based on the access point information stored in the access point information management table 106a is found, and then the authentication is performed on the found access point using a security code. The access point connection controlling unit 102e then determines whether the authentication is successful (step SA-6).

If it is determined that the connection destination access point is found and the authentication is successful (Yes at step SA-6), the access point connection controlling unit 102e shifts the processing to step SA-10.

If it is determined that no connection destination access point is found or the authentication is unsuccessful (No at step SA-6), the access point connection controlling unit 102e shifts the processing to step SA-9.

If the communication via access point mode controlling unit 102c checks that the wireless boot mode is set to the automatic switching mode (automatic switching mode at step SA-2), the access point connection controlling unit 102e performs booting in the communication via access point mode (step SA-4) and tries to connect to five access points about when the access point information is stored in the access point information management table 106a in accordance with the wireless connection priority orders (in the order of priority) associated with the access points stored in the access point information management table 106a (step SA-5), and then shifts the processing to step SA-7.

The image-reading apparatus 100 may search for the connectable AP because the image-reading apparatus 100 operates in the communication via access point mode. In this way, in the embodiment, the wireless setting of AP can be preliminarily registered up to five APs and connection priority order may be capable of being specified. In the embodiment, the connectable AP is searched out of the wireless settings of APs preliminarily registered, thereby reducing the search time.

When the image controlling unit 102a is set to the power saving mode (apparatus power-saving state), the access point connection controlling unit 102e may operate in the communication via access point mode in synchronization with (following) the power saving mode of the image controlling unit 102a. In the embodiment, the firmware 30 may instruct the driver 20 to boot the image-reading apparatus 100 in the communication via access point mode. The firmware 30 may instruct the driver 20 to synchronize the apparatus power-saving state with the operation of the power save mode (a function to reduce power consumption by periodically repeating sleep and wake up while maintaining wireless communication) included in the wireless LAN communication chip 114.

The access point connection controlling unit 102e determines whether the connection destination access point based on the access point information stored in the access point information management table 106a is found (step SA-7). The access point connection controlling unit 102e may determine whether the presence of the connectable AP is checked.

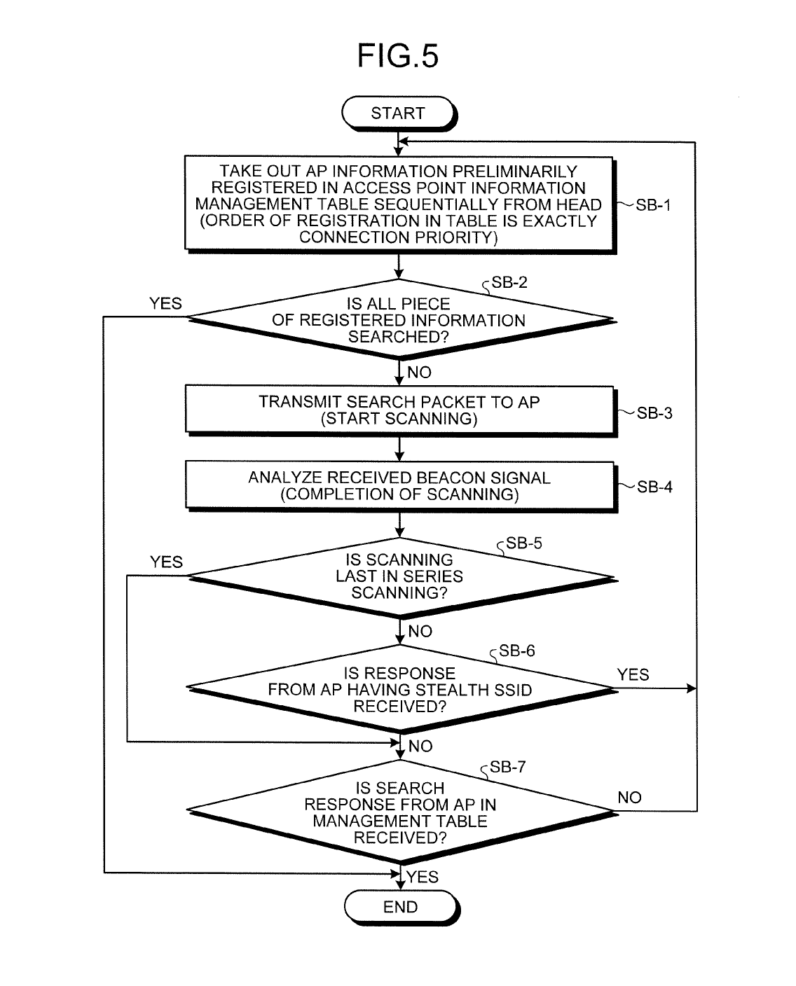

The following explains an example of the access point search processing according to the embodiment with reference to FIGS. 5 to 7. FIG. 5 is a flowchart of an example of the processing according to the image-reading apparatus 100 of the embodiment.

As shown in FIG. 5, the access point connection controlling unit 102e takes out (acquires) the access point information preliminarily registered in the access point information management table 106a sequentially from the head (in the order of wireless connection priority) (step SB-1). In the embodiment, the firmware 30 may take out the AP information registered in the access point information management table 106a one by one in the order of registration in the table. The order of registration of the access point information in the access point information management table 106a may be exactly the wireless connection priority. In the embodiment, the processing proceeds in the order of registration in the table. The order thus may be exactly the connection priority.

The access point connection controlling unit 102e determines whether all pieces of the registration information in the access point information management table 106a are searched (step SB-2).

If it is determined that all pieces of the registration information in the access point information management table 106a are searched (Yes at step SB-2), the access point connection controlling unit 102e ends the processing on the basis of the determination that no wirelessly connectable access point is included. In other words, the access point connection controlling unit 102e ends the processing on the basis of the determination that no connectable AP is included when all pieces of the registration information (e.g., five pieces of information) are checked and no connectable AP is found.

If it is determined that all pieces of the registration information in the access point information management table 106a are not searched (No at step SB-2), the access point connection controlling unit 102e transmits search packets to the APs (starts scanning for the APs) (step SB-3). The access point connection controlling unit 102e may transmit the search packets in a broadcast manner on the basis of the information about APs taken out from the access point information management table 106a.

The access point connection controlling unit 102e analyzes the beacon signals received from the access points (completion of the scanning for the APs) (step SB-4). The access point connection controlling unit 102e may analyze the beacon signals received from the respective APs while transmitting the search packets. In the embodiment, the scanning processing of a single AP may be performed at step SB-3 and step SB-4 (at the steps, only the scanning is performed and a determination of presence or absence of response information is not performed).

The access point connection controlling unit 102e determines whether the scanning is the last in the series scanning for the access points (step SB-5). The access point connection controlling unit 102e may determine whether all pieces of the wireless connectable APs registered in the access point information management table 106a are scanned.

If it is determined that the scanning is the last in the series scanning for the access points (Yes at step SE-3), the access point connection controlling unit 102e shifts the processing to step SB-7.

If it is determined that the scanning is not the last in the series scanning for the access points (No at step SB-5), the access point connection controlling unit 102e determines whether the beacon signal including no identification information (Service Set Identifier: SSID) about the access point is received during the scanning for the access points, that is, whether a response from an access point having a stealth SSID is received (step SB-6).

If it is determined that a response from an access point having a stealth SSID is received (Yes at step SB-6), the access point connection controlling unit 102e shifts the processing to step SB-1.

If it is determined that no response from an access point having a stealth SSID is received (No at step SB-6), the access point connection controlling unit 102e shifts the processing to step SB-7. In this way, the access point connection controlling unit 102e may perform control such that the access point connection controlling unit 102e checks presence or absence of a response from an AP having a stealth SSID and the scanning operation is repeated thoroughly up to the last AP when any presence of the stealth SSID is detected.

The access point connection controlling unit 102e determines whether a search response from the access point registered in the access point information management table 106a is received (step SB-7). When no presence of an AP having a stealth SSID is detected, the access point connection controlling unit 102e checks the response information caused by the scanning processing.

In the embodiment, matching processing that checks the presence or absence of the search response from the AP registered in the access point information management table 106a may be performed every time on all pieces of the registered AP information. It is because the determination of presence or absence of the response information is also done on the response information with the beacon signal. In the embodiment, even when no response is checked from a certain AP in the scanning processing of the AP, it can be determined that the connection destination AP is present in the case where the response information with the beacon signal is obtained from the AP serving as the next search target. As a result, in the embodiment, redundant search processing is skipped and the processing is completed at the point of the skip, thereby speeding up the search processing.

If it is determined that the search response from the access point registered in the access point information management table 106a is received (Yes at step SB-7), the access point connection controlling unit 102e determines that the connection destination access point is present and then ends the processing. In other words, once the presence of the AP is checked, the access point connection controlling unit 102e determines that the connection destination AP is present at the point of the check and then ends the processing.

If it is determined that no search response from the access point registered in the access point information management table 106a is received (No at step SB-7), the access point connection controlling unit 102e skips a waiting time, that is, instantly, shifts the processing to step SB-1.

When the presence of the AP is not checked (no search response is received), the access point connection controlling unit 132e may promptly change the processing target to the next AP. In typical AP search processing, a waiting time is set to five seconds to reduce congestion in network traffic. In the embodiment, however, the control is instantly performed on the AP serving as the next processing target without a waiting time to promptly find the connectable AP, thereby speeding up the search processing.

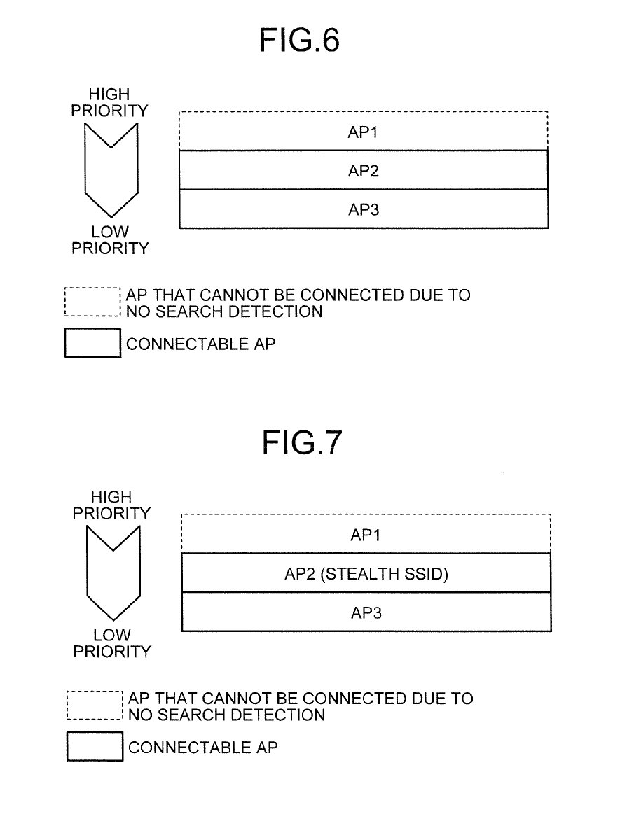

The following explains an example of the access point search processing according to the embodiment with reference to FIGS. 6 and 7. FIGS. 6 and 7 are conceptual schematic diagrams of an example of the access point search processing according to the embodiment.

As shown in FIG. 6, the access point connection controlling unit 102e normally searches the AP information (AP1, AP2, and AP3) registered in the access point information management table 106a sequentially from the AP1 having the highest priority. Even when the response from the AP1 is not obtained by the search (connection cannot be established due to no search detection), the access point connection controlling unit 102e detects the beacon signal and searches for a connectable access point on the basis of the beacon signal. The access point connection controlling unit 102e determines the AP2 having the second highest priority next to that of the AP1 as the connection target. When the AP having the high priority is not found due to a reason of a power source being off or the like, the access point connection controlling unit 102e searches for the next connection destination from the beacon signal and, when the connection target is found, cancels the search for the access point having a lower priority than that of the connection target, thereby making it possible to speed up the search processing.

The processing when the stealth access point is included in the access points serving as the search targets is explained. As shown in FIG. 7, the access point connection controlling unit 102e detects the beacon signal and searches for a connectable access point on the basis of the beacon signal when no response is obtained after searching for the AP1 having the high priority out of the AP information registered in the access point information management table 106a. The access point connection controlling unit 102e cannot detect the SSID of the AP2, which is set as the stealth access point and has a priority next to that of the AP1, from the beacon signal and thus misidentifies the AP3 having a priority next to that of the AP2 as the connection target. To avoid such misidentification, control is performed such that the scanning operation is repeated up to the last AP when the beacon from which no SSID is detected is present. In this way, the access point connection controlling unit 102e performs control and determines the connection target after the search of all of the access points is completed such that the scanning is performed thoroughly up to the last AP to eliminate a mistaken case where the AP having a lower priority is mistakenly matched as the search target in advance due to no detection of SSID of the stealth AP from the beacon signal.

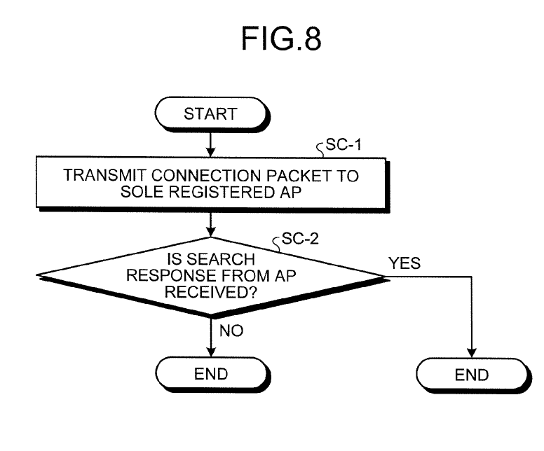

The following explains an example of the access point search processing when a single access point is registered according to the embodiment with reference to FIG. 8. FIG. 8 is a flowchart of an example of the processing according to the image-reading apparatus 100 of the embodiment.

As shown in FIG. 8, the access point connection controlling unit 102e transmits a connection packet to the access point based on a sole access point information is registered in the access point information management table 106a (step SC-1).

The access point connection controlling unit 102e determines whether the search response from the access point is received (step SC-2).

If it is determined that no search response from the access point is received (No at step SC-2), the access point connection controlling unit 102e determines that no connection destination AP is present and then ends the processing.

If it is determined that the search response from the access point is received (Yes at step SC-2), the access point connection controlling unit 102e determines that the connection destination AP is present and then ends the processing. In this way, because only one AP to be connected is registered, the access point connection controlling unit 102e may transmit the search packet to the sole AP in the search processing and determine the presence or absence of the connectable AP on the basis of the presence or the absence of the response information.

Referring back to FIG. 4, if it is determined that the connection destination access point based on the access point information stored in the access point information management table 106a is not found (No at step SA-7), the access point connection controlling unit 102e shifts the processing to step SA-3. In this way, in the embodiment, even though a user moves to an environment where the AP that the user can use is absent, such as the business trip destination, the wireless boot mode is automatically switched to the direct communication mode. As a result, the scanner can be wirelessly used by direct communication. In addition, in the embodiment, the measure that reduces time taken to be automatically connected allows the user to use the scanner with no stress.

If it is determined that the connection destination access point based on the access point information stored in the access point information management table 106a is found (Yes at step SA-7), the access point connection controlling unit 102e shifts the processing to step SA-8.

The access point connection controlling unit 102e authenticates the found access point using a security code and determines whether the authentication is successful (step SA-8).

If it is determined that the authentication using the security code is unsuccessful (No at step SA-8), the access point connection controlling unit 102e shifts the processing to step SA-9.

The wireless connection controlling unit 102f operates in still the communication via access point mode in the authentication error state (in an unconnected state) (step SA-9), and then ends the processing. The wireless connection controlling unit 102f may continue to operate in the communication via access point mode in the authentication error state, that is, in the state of being unconnected with the AP, when the authentication is unsuccessful.

If it is determined that the authentication using the security code is successful (Yes at step SA-8), the access point connection controlling unit 102e shifts the processing to step SA-10.

The wireless connection controlling unit 102f wirelessly connects to the access point in a normal way in the communication via access point mode (step SA-10), and then ends the processing.

When the image controlling unit 102a is in the power saving mode (apparatus power-saving state), the wireless connection controlling unit 102f may perform wireless connection in the communication via access point mode in a power saving mode in synchronization with the power saving mode of the image controlling unit 102a (maintaining the following state). In other words, the wireless connection controlling unit 102f may operate while connecting to the AP in a normal way in the communication via access point mode when the authentication using the security code is successful. In the embodiment, an ideal power saving function may be provided by the power saving control suitable for the wireless connection scheme.

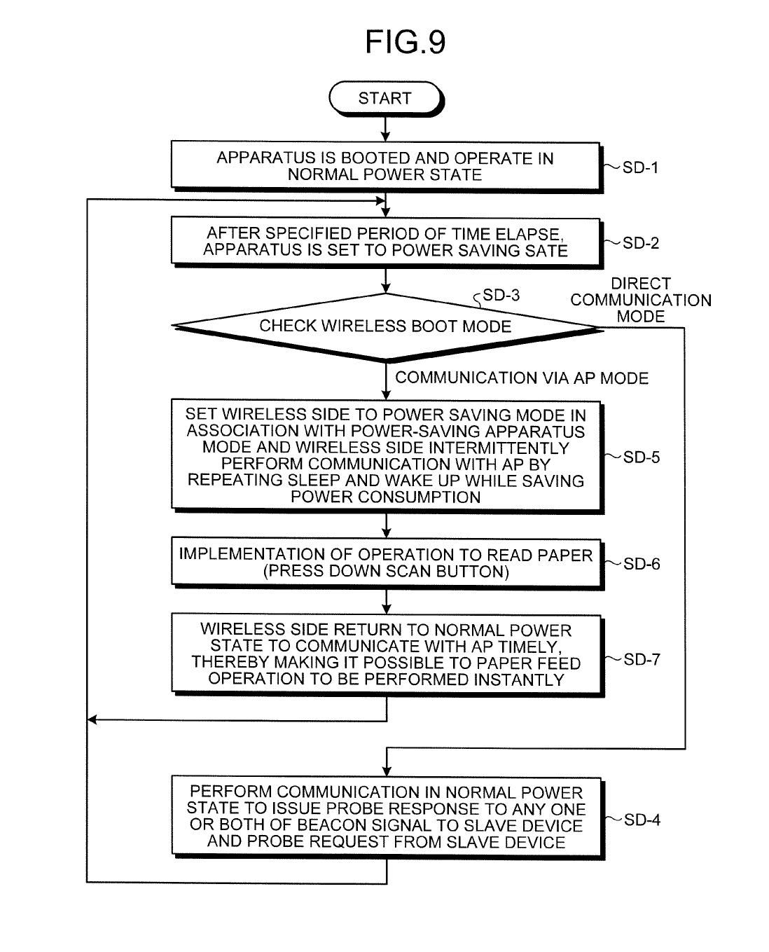

The following explains an example of the wireless power saving control in synchronization with the apparatus power saving control according to the embodiment with reference to FIG. 9. FIG. 9 is a flowchart of an example of the processing according to the image-reading apparatus 100 of the embodiment.

As shown in FIG. 9, when a user instructs the boot of the image-reading apparatus 100 through the input/output unit 112, the image controlling unit 102a operates the image-reading control in a normal power state (step SD-1).

After a specified period of time elapses, if the image controlling unit 102a is set to the power saving mode (step SD-2), the control unit 102 checks that the wireless boot mode operates in which one of the direct communication mode and the communication via access point mode (step SD-3).

If the control unit 102 checks that the wireless boot mode operates in the direct communication mode (direct communication mode at step SD-3), the wireless connection controlling unit 102f performs communication in the normal power state to issue any one or both of the beacon signal to the terminal device (slave device) 400 and a probe response to a probe request from the terminal device (slave device) 400 (step SD-4), and then shifts the processing to step SD-2.

If the control unit 102 checks that the wireless boot mode operates in the communication via access point mode (communication via access point mode at step SD-3), the wireless connection controlling unit 102f sets the wireless side to the power saving mode in synchronization with the power saving mode (apparatus power saving mode) of the image controlling unit 102a and the wireless side intermittently communicates with the access point while reducing the power consumption by repeating sleep and wake up (step SD-5).

When the user instructs the implementation of the operation to read paper through the input/output unit 112, that is, presses down a scan button, the image controlling unit 102a returns to the normal power state and operates the image-reading control (step SD-6).

The wireless connection controlling unit 102f causes the wireless side to return to the normal power state and the wireless side communicates timely with the access point (step SD-7), and then shifts the processing to step SD-2. As a result, the embodiment makes it possible to the paper feed operation to be performed instantly. The processing may be ended by turning off the power source of the image-reading apparatus 100. In this way, in the embodiment, the wireless side may be set to the power saving state following the power saving state of the image-reading apparatus 100 when the wireless boot mode is switched.

In the embodiment, the image-reading apparatus 100 may have a function to be automatically set to the power saving mode after a specified period of time elapses in the continuous operation of the image-reading apparatus 100 from the establishment of the wireless boot mode. In such a case, in the embodiment, the wireless side may also automatically select an optimum power saving operation based on the wireless boot mode in synchronization with the power saving of the image-reading apparatus 100. As a result, the embodiment makes it possible to perform optimum power saving management on the apparatus and the wireless side.

As described above, in the embodiment, the image-reading apparatus 100, which is supposed to be used in a portable manner, can transmit the scanned image data to a medium by not only wired communication but also wireless communication, thereby enhancing user-friendliness. In the embodiment, the wireless communication may be a scheme in which the communication is performed via the AP that the user can use in an environment such as the user's home or workplace (an automatic wireless connection with the AP when the user carries the image-reading apparatus 100 in an environment where the AP that the user can use is present such as the user's home or workplace) and a scheme in which the communication is performed directly with the image-reading apparatus 100 in an environment such as a business trip destination or an airport.

Conventionally, the AP to be used needs to be designated when the communication is performed via the AP, thereby requiring a user to perform wireless setting every time the usage environment is changed. Conventionally, the image-reading apparatus 100 provided with two chips can control the communication via access point mode and the direct communication mode using the respective chips. The image-reading apparatus 100 provided with a single chip, however, cannot control both modes, thereby requiring a user to change the mode depending on the environment. The embodiment makes it possible to automate and eliminate the troublesome setting that the user needs to perform every time the usage environment is changed.

In the embodiment, it is tried to connect to a plurality of APs preliminarily registered using a setting tool when the image-reading apparatus 100 is booted. In the embodiment, the connection is tried one by one out of a plurality of wireless settings in accordance with the priority order, and is stopped at the setting by which the connection is established. As a result, communication is available. In the embodiment, to perform the operation based on the user's intention, the try can also be stopped when the connection is not established while the registered AP is present (e.g., when a password is changed). The embodiment makes it possible to automatically switch the mode to the direct communication mode when the registered AP is absent and the connection is thus not established. The embodiment makes it possible for a user to designate the connection operation of the image-reading apparatus 100 out of the following three ways: the automatic switching, only via the AP, and only the direct communication.

In the embodiment, to reduce the wireless connection attempt time, a waiting time of five seconds from the scanning for a certain AP to that for the next AP is skipped and the target APs are instantly searched in the control of the scanning for the multiple APs. In the embodiment, when the presence of the registered AP having a high priority is checked on the basis of the received beacon signal, the connection attempt is stopped at the point of the check and the state can be changed to a communication available state.

In the embodiment, the image-reading apparatus 100 has a power saving function, which can causes the whole of the apparatus to be changed to a quiescent state when no operation is received from a user for a certain period of time. In such a case, in the embodiment, the wireless function is also changed to the quiescent state in synchronization with the change while maintaining the communication with the AP when the mode is communication via access point mode, thereby making it possible to contribute the reduction of power consumption of the apparatus. In the embodiment, when the mode is the direct communication mode in which the wireless communication needs to be consistently performed, the control can be performed such that only the wireless unit is operated normally to cause the wireless unit to prioritize the function as the AP even when the whole of the apparatus is in the quiescent state.

### 4. Other Embodiments

The embodiment of the present invention is explained above. However, the present invention may be implemented in various different embodiments other than the embodiment described above within a technical scope described in claims.

For example, the image-reading apparatus 100 may perform processing in a stand-alone form. The image-reading apparatus 100 may perform processing in accordance with the request from a client terminal (another different housing from the image-reading apparatus 100) and return the processing result to the client terminal.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters like search conditions, display examples, and database constructions, mentioned in the description and drawings can be changed as required unless otherwise specified.

The constituent elements of the image-reading apparatus 100 are merely conceptual and may not necessarily physically resemble the structures shown in the drawings.

For example, the process functions performed by each device of the image-reading apparatus 100, especially the each process function performed by the control unit 102, can be entirely or partially implemented by CPU and a computer program executed by the CPU or by hardware using wired logic. The computer program, recorded on a non-transitory tangible computer readable recording medium including programmed commands for causing a computer to execute the method of the present invention, can be mechanically read by the image-reading apparatus 100 as the situation demands. In other words, the storage unit 106 such as a ROM or a hard disk drive (HDD) stores the computer program that can work in coordination with an operating system (OS) to issue commands to the CPU and cause the CPU to perform various processes. The computer program is first loaded to a RAM, and forms the control unit in collaboration with the CPU.

Alternatively, the computer program can be stored in any application program server connected to the image-reading apparatus 100 via any network, and can be fully or partially loaded as the situation demands.

The computer program according to the invention may be stored in a computer-readable recording medium, or may be structured as a program product. Here, the “recording medium” includes any “portable physical medium” like a memory card, a universal serial bus (USB) memory, a secure digital (SD) card, a flexible disk, a magnetic optical (MO) disc, a ROM, an erasable programmable read only memory (EPROM), an electronically erasable and programmable read only memory (EEPROM), a compact disc read only memory (CD-ROM), a digital versatile disc (DVD), and a Blu-ray (registered trademark) disc.

In addition, a “program” is a data processing method that is described in an arbitrary language or a description method and may have an arbitrary form like a source code, a binary code, or the like. Furthermore, the “program” is not necessarily limited to a configuration of a single form and includes a configuration in which the program is configured by a plurality of modules or a plurality of program libraries in a distributed manner and includes a program that achieves the function thereof in cooperation with a separate program that is represented by an OS. In addition, as a specific configuration for reading data from a recording medium in each apparatus illustrated in the embodiments, a reading procedure, an installation procedure after the reading, and the like, a known configuration and a known procedure may be used.

Various databases stored in the storage unit 106 is a storage unit such as a memory device such as a RAM or a ROM, a fixed disk device such as an HDD, or any one or both of a flexible disk and an optical disc, and stores various programs, tables, and any one or both of databases and web page files used for providing various processing or web sites.

The image-reading apparatus 100 may be structured by connecting any peripheral devices to an information processing apparatus like a known personal computer or workstation. Furthermore, the image-reading apparatus 100 may be achieved by mounting software (including programs, data, or the like) for causing the information processing apparatus to implement the method according of the invention.

The distribution and integration of the device are not limited to those illustrated in the figures. The device as a whole or in parts can be functionally or physically distributed or integrated in an arbitrary unit according to various attachments or how the device is to be used. That is, any embodiments described above can be combined when implemented, or the embodiments can selectively be implemented.

According to the invention, a user preliminarily registers a wireless setting of an access point (AP) to which the user may connect, thereby making it possible for the user to automatically perform the wireless communication according to the user's intention without setting again the wireless setting of a scanner depending on an environment of a destination to which the user carries the scanner, such as the user's home or workplace.

The present invention can control both of a communication via access point mode and a direct communication mode at once.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image-reading apparatus, comprising:
a wireless local area network communication chip that is capable of performing wireless connection in a communication via access point mode and a direct communication mode;
an access point information storage unit that stores access point information about a plurality of access points;
an access point connection controlling unit that tries to connect to an access point based on the access point information stored in the access point information storage unit; and
a wireless connection controlling unit that performs the wireless connection in the communication via access point mode when the connection to the access point is successful.

2. The image-reading apparatus according to claim 1, further comprising:
an image controlling unit that controls an image reading, wherein
when the image controlling unit is set to a power saving mode during the wireless connection in the communication via access point mode, the wireless connection controlling unit performs the wireless connection in the communication via access point mode in a power saving mode in synchronization with the power saving mode, whereas when the image controlling unit is set to the power saving mode during the wireless connection in the direct communication mode, the wireless connection controlling unit performs the wireless connection in the direct communication mode without any synchronization with the power saving mode.

3. The image-reading apparatus according to claim 1, wherein, when performing search processing on the access point based on the access point information stored in the access point information storage unit and receiving no search response from the access point, the access point connection controlling unit skips a waiting time and performs the search processing on another access point that is different from the access point and based on the access point information stored in the access point information storage unit.

4. The image-reading apparatus according to claim 1, wherein the wireless connection controlling unit performs the wireless connection in the direct communication mode when the access point based on the access point information stored in the access point information storage unit is not found.

5. The image-reading apparatus according to claim 1, wherein the wireless connection controlling unit operates still in the communication via access point mode when the access point based on the access point information stored in the access point information storage unit is found and authentication of the access point is unsuccessful.

6. The image-reading apparatus according to claim 1, wherein, when a beacon signal is received and the beacon signal is transmitted from the access point based on the access point information stored in the access point information storage unit, the access point connection controlling unit tries to connect to the access point that transmits the beacon signal.

7. The image-reading apparatus according to claim 6, wherein the access point connection controlling unit tries to connect to the access point that transmits the beacon signal when querying the access point and receiving a response from the access point in receiving the beacon signal including no identification information about the access point, and when the beacon signal is transmitted from the access point based on the access point information stored in the access point information storage unit after search processing of all of the access points is completed.

8. The image-reading apparatus according to claim 1, wherein
the access point information storage unit stores connection priority order information about a priority order of the wireless connection, the priority order being associated with the access point, and
the access point connection controlling unit tires to connect to the access point based on the access point information stored in the access point information storage unit in accordance with the priority order.

9. The image-reading apparatus according to claim 1, wherein the image-reading apparatus is a mobile type image-reading apparatus.

10. The image-reading apparatus according to claim 1, wherein the image-reading apparatus includes the single wireless local area network communication chip.

11. An image processing method executed by an image-reading apparatus, the image processing method comprising:
an access point connection controlling step of trying to connect to an access point based on access point information stored in an access point information storage unit that stores the access point information about a plurality of access points; and
a wireless connection controlling step of performing a wireless connection in a communication via access point mode through a wireless local area network communication chip that is capable of performing the wireless connection in the communication via access point mode and a direct communication mode, when the connection to the access point is successful.

12. The image processing method according to claim 11, further comprising:
an image controlling step of controlling an image reading, wherein
at the wireless connection controlling step, when the image reading controlled at the image controlling step is set to a power saving mode while the wireless connection being performed in the communication via access point mode, the wireless connection in the communication via access point mode is performed in a power saving mode, whereas when the image reading controlled at the image controlling step is set to the power saving mode while the wireless connection being performed in the direct communication mode, the wireless connection is performed in the direct communication mode without any synchronization with the power saving mode.

13. The image processing method according to claim 11, wherein, at the access point connection controlling step, when search processing is performed on the access point based on the access point information stored in the access point information storage unit and no search response is received from the access point, a waiting time is skipped, and the search processing is performed on another access point that is different from the access point and based on the access point information stored in the access point information storage unit.

14. The image processing method according to claim 11, wherein, at the wireless connection controlling step, when the access point based on the access point information stored in the access point information storage unit is not found, the wireless connection is performed in the direct communication mode.

15. The image processing method according to claim 11, wherein, at the wireless connection controlling step, when the access point based on the access point information stored in the access point information storage unit is found and authentication of the access point is unsuccessful, an operation still remains in the communication via access point mode.

16. The image processing method according to claim 11, wherein, at the access point connection controlling step, when a beacon signal is received and the beacon signal is transmitted from the access point based on the access point information stored in the access point information storage unit, a connection to the access point that transmits the beacon signal is tried.

17. The image processing method according to claim 16, wherein, at the access point connection controlling step, the connection to the access point that transmits the beacon signal is tried when querying the access point and receiving a response from the access point in receiving the beacon signal including no identification information about the access point, and when the beacon signal is transmitted from the access point based on the access point information stored in the access point information storage unit after search processing of all of the access points is completed.

18. The image processing method according to claim 11, wherein
the access point information storage unit stores connection priority information about a priority order of the wireless connection, the priority order being associated with the access point, and
at the access point connection controlling step, connection to the access point based on the access point information stored in the access point information storage unit is tried in accordance with the priority order.

19. The image processing method according to claim 11, wherein the image-reading apparatus is a mobile type image-reading apparatus.

20. The image processing method according to claim 11, wherein the image-reading apparatus includes the single wireless local area network communication chip.
